(19) United States
(12) Patent Application Publication
(10) Pub. No.: US 2018/0151081 A1
(43) Pub. Date: May 31, 2018

(54) AUTOMATICALLY GENERATED TOPIC LINKS

(71) Applicant: COURSERA, INC., Mountain View, CA (US)

(72) Inventors: Zhenghao CHEN, Palo Alto, CA (US); Jiquan NGIAM, Mountain View, CA (US); Daphne KOLLER, Portola Valley, CA (US)

(21) Appl. No.: 15/363,707

(22) Filed: Nov. 29, 2016

(51) Int. Cl. G09B 5/02; G06F 17/30

(52) U.S. Cl. CPC G09B 5/02; G06F 17/30011; G06F 17/30675

(57) ABSTRACT

Techniques of providing references to students of massive open online courses (MOOCs) involve automatically providing references based on semantic content of queries generated within a MOOC. Along these lines, a computer browser in which a user interacts with a MOOC may generate queries for additional reference material to supplement its content. For example, the browser may generate a query based on the results of an exam taken by a student in order to provide additional help in areas where the student did not do well. When the query is received by a reference generating server, the reference generating server computes similarity scores indicating a measure if similarity between keyword elements of the query and keyword elements of reference documents. The reference generating server then sends references to the student based on the similarity scores.

### TECHNICAL FIELD

This description relates to generating reference material for massive open online courses (MOOCs).

### BACKGROUND

MOOCs include course materials on various media such as text documents, audio, and video that contain the course content. Students follow a protocol for studying the course content in order to master the subject matter of a course. The students evaluate their mastery of the subject matter through tests, homework, and other projects.

### SUMMARY

In one general aspect, a method of providing references to electronic documents to a student of a MOOC can include obtaining, by processing circuitry of a computer, a set of electronic documents, the set of electronic documents including a first set of keyword elements. The method can also include receiving, by the processing circuitry, a query from a student of the MOOC, the query including a second set of keyword elements. The method can further include, in response to receiving the query, for each of the second set of keyword elements, generating, by the processing circuitry, a similarity score between a keyword element of the first set of keyword elements and each of the second set of keyword elements. The method can further include performing, by the processing circuitry, a selection operation based on the similarity score to select a reference to an electronic document of the set of electronic documents that include the keyword element to the student of the MOOC.

In another general aspect, a method of providing references to electronic documents to a student of a MOOC can include generating a query based on content of the MOOC, the query including a set of keyword elements describing the content. The method can also include sending the query to a reference generating server, the reference generating server being configured to locate an electronic document that include keyword elements describing content that is semantically similar to the content of the MOOC. The method can further include receiving a reference to the electronic document from the reference generating server, the set of references providing the student of the MOOC with additional content for the MOOC.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram that illustrates an example electronic environment according to an implementation of improved techniques described herein.

FIG. 2 is a diagram that illustrates another example electronic environment according to an implementation of improved techniques described herein.

FIG. 3 is a flow chart illustrating an example method according to the improved techniques described herein.

FIG. 4 is a flow chart illustrating another example method according to the improved techniques described herein.

FIG. 5 is a graph illustrating a semantic embedding model according to the improved techniques described herein.

### DETAILED DESCRIPTION

As discussed above, MOOCs include course materials on various media such as text documents, audio, and video that contain the course content. Students participating in a MOOC may require further reference information beyond what the course materials offer. Conventional techniques of providing references involve locating that material manually. For example, when a student tests poorly in a particular area of a course the student may perform searches on the Internet for additional material in that particular area. However, many times those searches do not result in helpful material as the student may have limited understanding of the particular area.

In contrast to the above-described conventional techniques of providing references to students of MOOCs, improved techniques involve automatically providing references based on semantic content of queries generated within a MOOC. Along these lines, a computer browser in which a user interacts with a MOOC may generate queries for additional reference material to supplement its content. For example, the browser may generate a query based on the results of an exam taken by a student in order to provide additional help in areas where the student did not do well. When the query is received by a reference generating server, the reference generating server computes similarity scores indicating a measure of similarity between keyword elements (e.g., keywords, phrases, sentences, etc., but also non-textual elements such as graphics, audio, and video) of the query and keyword elements of reference documents. The reference generating server then sends references to the student based on the similarity scores. Advantageously, computation of such similarity scores may be used to automatically provide students with additional instructional material (e.g., Wikipedia pages, white papers, etc.) based on demonstrated areas of need from exam results.

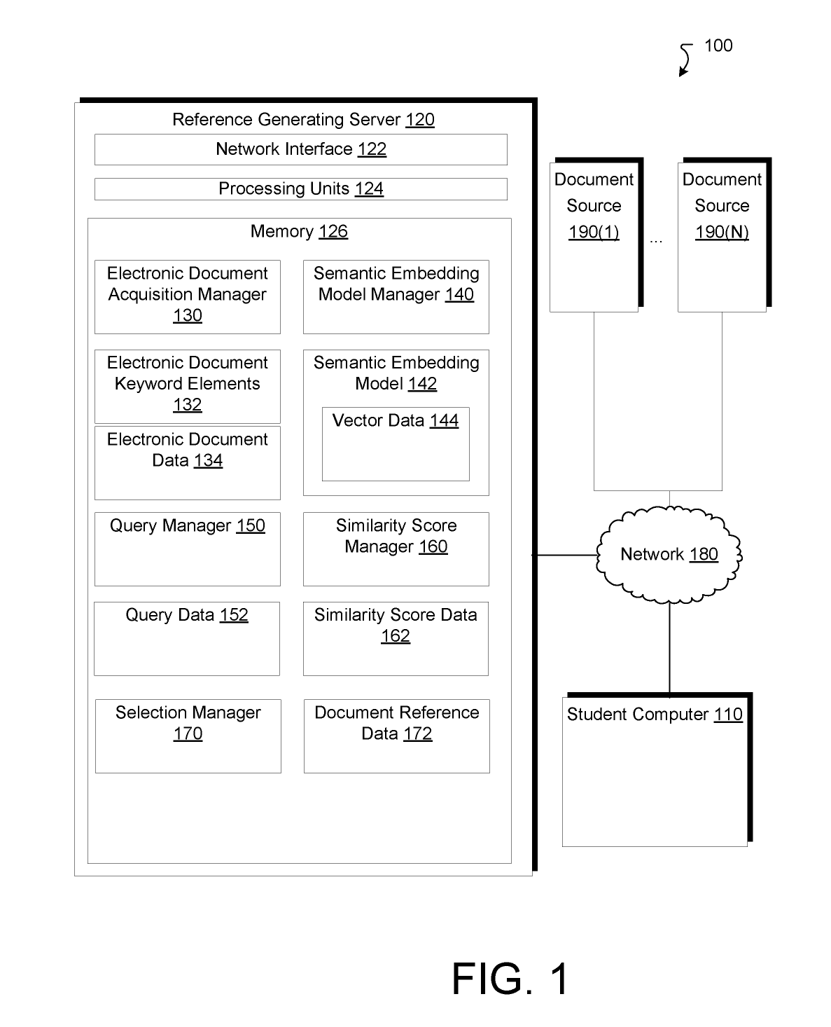

FIG. 1 is a diagram that illustrates an example electronic environment 100 in which the above-described improved techniques may be implemented. As shown, in FIG. 1, the example electronic environment 100 includes a student computer 110, a reference generating server 120, a network 180, and document sources 190(1), . . . , 190(N).

The reference generating server 120 is configured to provide references to a user of the student computer 110 upon receipt of a query from the student computer 110. The reference generating server 120 includes a network interface 122, one or more processing units 124, and memory 126. The network interface 122 includes, for example, Ethernet adaptors, Token Ring adaptors, and the like, for converting electronic and/or optical signals received from the network 180 to electronic form for use by the reference generating server 120. The set of processing units 124 include one or more processing chips and/or assemblies. The memory 126 includes both volatile memory (e.g., RAM) and non-volatile memory, such as one or more ROMs, disk drives, solid state drives, and the like. The set of processing units 124 and the memory 126 together form control circuitry, which is configured and arranged to carry out various methods and functions as described herein.

In some embodiments, one or more of the components of the reference generating server 120 can be, or can include processors (e.g., processing units 124) configured to process instructions stored in the memory 126. Examples of such instructions as depicted in FIG. 1 include an electronic document acquisition manager 130, a semantic embedding model manager 140, a query manager 150, a similarity score manager 160, and a selection manager 170. Further, as illustrated in FIG. 1, the memory 126 is configured to store various data, which is described with respect to the respective managers that use such data.

The electronic document acquisition manager 130 is configured to acquire electronic documents from the document sources 190(1), . . . , 190(N). For example, consider a MOOC for the topic of Complex Analysis. The electronic document manager 130 may perform a search over document sources 190(1), . . . , 190(N) for documents that have content related to Complex Analysis. Examples of such documents include Wikipedia pages, Stack Exchange pages, scholastic papers, and the like.

The electronic document acquisition manager 130 is also configured to parse each of the acquired electronic documents 134 to produce keyword elements 132 from each document. A keyword element 132 might be a relevant keyword, phrase, sentence, or the like that may be used in a search of the relevant subject matter. In the above example, such keyword elements may include “complex,” “complex analysis,” “complex number,” “imaginary number,” “analytic function,” “holomorphic function,” “complex integration,” and so on.

The semantic embedding model manager 140 is configured to generate a semantic embedding model 142 from the electronic document keyword elements 132 and the electronic document data 134. Examples of such a model include word2vec and doc2vec. Word2vec takes as its input a large corpus of text from keyword elements 132 and document data 134 and produces a high-dimensional space (typically of several hundred dimensions), with each unique word in the corpus being assigned a corresponding vector 144 in the space. Doc2vec embeds entire documents into respective vectors. Keyword element vectors 144 are positioned in the vector space such that keyword elements 132 that share common contexts in the document data 134 are located in close proximity to one another in the space.

The query manager 150 is configured to receive queries from the student computer 110. The query manager 150 is further configured to store query data 152, e.g., query keyword elements and other contextual data. For example, a query may contain text of a question from an exam that a student answered incorrectly.

The similarity score manager 160 is configured to compare keyword elements from the query data 152 with keyword elements 132 from the electronic document data 134. For example, the similarity score manager 160 may generate for each keyword element 132 a M-dimensional vector, where each component of such a vector represents a context in which that keyword element may or may not be used. Further, the similarity score manager 160 may also generate a M-dimensional vector for each keyword element of the query data 152. The similarity score 162 computed by the similarity score manager 160 is a metric indicating how semantically close the keyword elements from the electronic documents 134 and the keyword elements from the queries 152 are. An example of such a metric is a cosine metric which measures an angle between the M-dimensional vectors. Specifically, this example metric takes the form

$$D = 1 - \frac{1}{π} {cos}^{- 1} ( \frac{{v}_{d} \cdot {v}_{q}}{‖ {v}_{d} ‖ ‖ {v}_{q} ‖} ) ,$$

where v_{d} is a keyword element vector from document data 134 and v_{q} is a keyword element vector from the query data 152.

The selection manager 170 is configured to select one of more references to electronic documents 134 based on the similarity score data 162. In the example described above using the cosine metric, the selection manager 170 may locate those documents 134 associated with the similarity scores 162 greater than a specified threshold, e.g., 0.5, 0.8, 0.9, 0.95, and so on. In other implementations, the selection manager 170 may choose a fixed number of documents associated with the top similarity scores 162, e.g., the top 10 scores.

The network 180 is configured and arranged to provide network connections between the reference generating server 120 and the student computer 110. The network 180 may implement any of a variety of protocols and topologies that are in common use for communication over the Internet or other networks. Further, the network 180 may include various components (e.g., cables, switches/routers, gateways/bridges, etc.) that are used in such communications.

The document sources 190(10, . . . , 190(N) are configured to host interfaces that provide access to electronic documents. For example, source 190(1) may be a Wikipedia server. In some implementations, at least one of the sources 190(1), . . . , 190(N) may host another MOOC.

In some implementations, the memory 126 can be any type of memory such as a random-access memory, a disk drive memory, flash memory, and/or so forth. In some implementations, the memory 126 can be implemented as more than one memory component (e.g., more than one RAM component or disk drive memory) associated with the components of the reference generating server 120. In some implementations, the memory 126 can be a database memory. In some implementations, the memory 126 can be, or can include, a non-local memory. For example, the memory 126 can be, or can include, a memory shared by multiple devices (not shown). In some implementations, the memory 126 can be associated with a server device (not shown) within a network and configured to serve the components of the reference generating server 120.

The components (e.g., modules, processing units 124) of the reference generating server 120 can be configured to operate based on one or more platforms (e.g., one or more similar or different platforms) that can include one or more types of hardware, software, firmware, operating systems, runtime libraries, and/or so forth. In some implementations, the components of the reference generating server 120 can be configured to operate within a cluster of devices (e.g., a server farm). In such an implementation, the functionality and processing of the components of the reference generating server 120 can be distributed to several devices of the cluster of devices.

The components of the reference generating server 120 can be, or can include, any type of hardware and/or software configured to process attributes. In some implementations, one or more portions of the components shown in the components of the reference generating server 120 in FIG. 1 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the reference generating server 120 can be, or can include, a software module configured for execution by at least one processor (not shown). In some implementations, the functionality of the components can be included in different modules and/or different components than those shown in FIG. 1.

Although not shown, in some implementations, the components of the reference generating server 120 (or portions thereof) can be configured to operate within, for example, a data center (e.g., a cloud computing environment), a computer system, one or more server/host devices, and/or so forth. In some implementations, the components of the reference generating server 120 (or portions thereof) can be configured to operate within a network. Thus, the components of the reference generating server 120 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some embodiments, one or more of the components of the reference generating server 120 can be, or can include, processors configured to process instructions stored in a memory. For example, the electronic document acquisition manager 130 (and/or a portion thereof), the semantic embedding model manager 140 (and/or a portion thereof), the query manager 150 (and/or a portion thereof), the similarity score manager 160, (and/or a portion thereof), and the selection manager 170 (and/or a portion thereof) can be a combination of a processor and a memory configured to execute instructions related to a process to implement one or more functions.

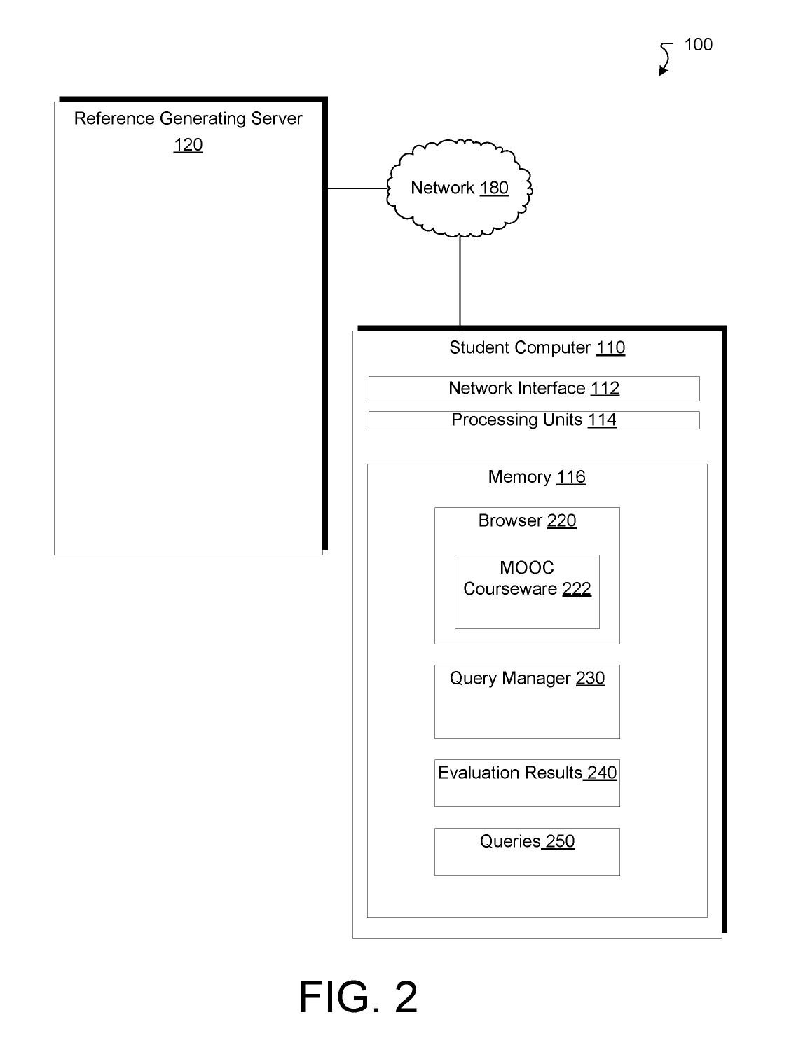

FIG. 2 is a diagram that illustrates another example electronic environment 200 in which the above-described improved techniques may be implemented. As shown, in FIG. 2, the example electronic environment 200 includes the student computer 110, the reference generating server 120, and the network 180.

The student computer 110 is configured to provide a student of a MOOC with interactive tools for experiencing the course content. Such tools may include audio, video, and/or textual lectures, exercises, and exams. The student computer 110 is also configured to generate queries for references containing additional course content based on the student's actions. For example, if the student appears to be struggling in a particular topic, then the student computer 110 may generate queries based on that topic. The student computer 110 includes a network interface 112, one or more processing units 114, and memory 116. The network interface 112 includes, for example, Ethernet adaptors, Token Ring adaptors, and the like, for converting electronic and/or optical signals received from the network 180 to electronic form for use by the student computer 110. The set of processing units 114 include one or more processing chips and/or assemblies. The memory 116 includes both volatile memory (e.g., RAM) and non-volatile memory, such as one or more ROMs, disk drives, solid state drives, and the like. The set of processing units 114 and the memory 116 together form control circuitry, which is configured and arranged to carry out various methods and functions as described herein.

In some embodiments, one or more of the components of the reference student computer 110 can be, or can include processors (e.g., processing units 114) configured to process instructions stored in the memory 116. Examples of such instructions as depicted in FIG. 2 include an Internet browser 220 that is configured to run MOOC courseware 222 and a query manager 230. Further, as illustrated in FIG. 1, the memory 126 is configured to store various data, which is described with respect to the respective managers that use such data.

The Internet browser 220 may be any browser that is capable of running software for the MOOC. For example, the courseware for a MOOC may be a Javascript program; in such a case, the Internet browser 220 should be capable of running Javascript programs.

The query manager 230 is configured to generate queries 250 for references based on student activity such as evaluation (e.g., exam, homework) results 240. For example, consider as above a course in Complex Analysis. Along these lines, a student may have taken an exam covering the whole course and did well except in the area of conformal mappings. The query manager 230 may form queries directly from those questions 240 the student answered incorrectly. In this case, for example, a query 250 might take the form of “solve Laplace's equation on a semicircle by defining a conformal map between the semicircle and a unit disk.” The query 250 may have keyword elements “Laplace's equation,”, “conformal map,” “semicircle,” and “unit disk.” The student computer 110 may then send the query 250 to the reference generating server 120 in order to acquire further reference material from which to study conformal mappings further.

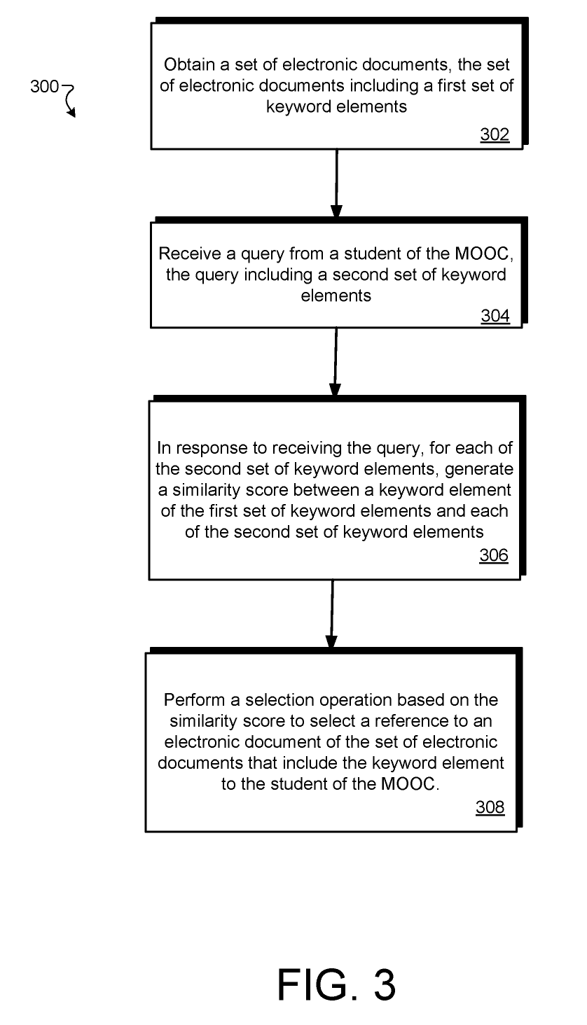

FIG. 3 is a flow chart that illustrates an example method 300 of providing references to electronic documents to a student of a MOOC. The method 300 may be performed by software constructs described in connection with FIG. 1, which reside in memory 126 of the reference generating server 120 and are run by the set of processing units 124.

At 302, a set of electronic documents 134 are obtained by the electronic document acquisition manager 130. The set of electronic documents 134 include a first set of keyword elements 132.

At 304, a query is received via query manager 150 from a student computer 110, the query including a second set of keyword elements 152.

At 306, in response to receiving the query, for each of the second set of keyword elements 152, a similarity score 162 between a keyword element of the first set of keyword elements 132 and each of the second set of keyword elements 152 is generated by the similarity score manager 160.

At 308, a selection operation is performed by the selection manager 170 based on the similarity score 162 to select a reference 172 to an electronic document of the set of electronic documents 134 that include the keyword element 152 to the student computer 110.

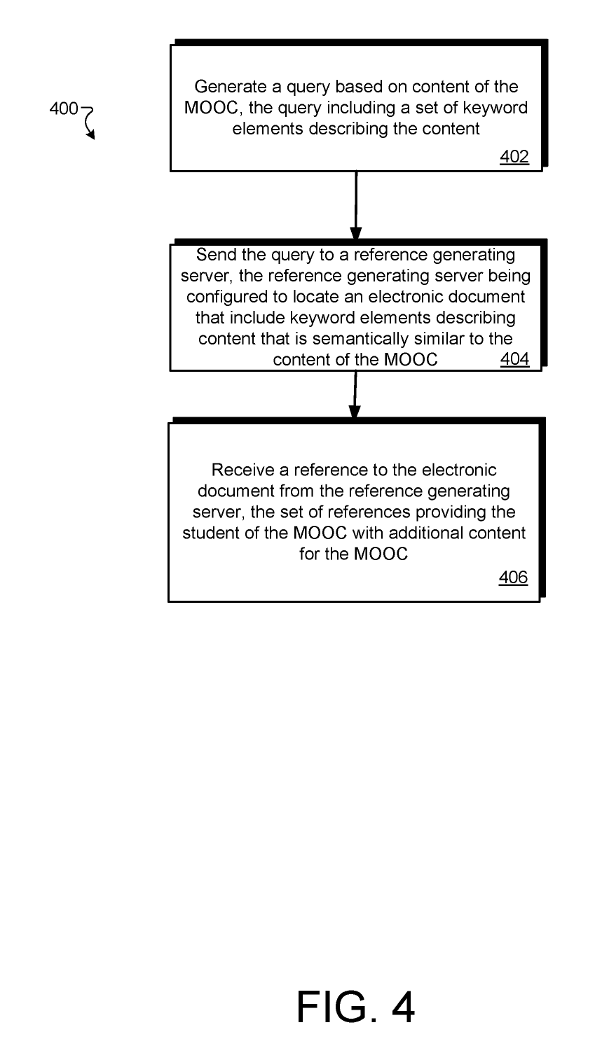

FIG. 4 is a flow chart that illustrates an example method 400 of providing references to electronic documents to a student of a MOOC. The method 400 may be performed by constructs described in connection with FIG. 2, which reside in memory 116 of the point student computer 110 and are run by the set of processing units 114.

At 402, a query 250 is generated by the query manager 230 based on content of the MOOC, the query 250 including a set of keyword elements describing the content.

At 404, the query 250 is sent to a reference generating server 120, the reference generating server 120 being configured to locate an electronic document that include keyword elements describing content that is semantically similar to the content of the MOOC.

At 406, a reference to the electronic document is received from the reference generating server 120, the reference providing the student of the MOOC with additional content for the MOOC.

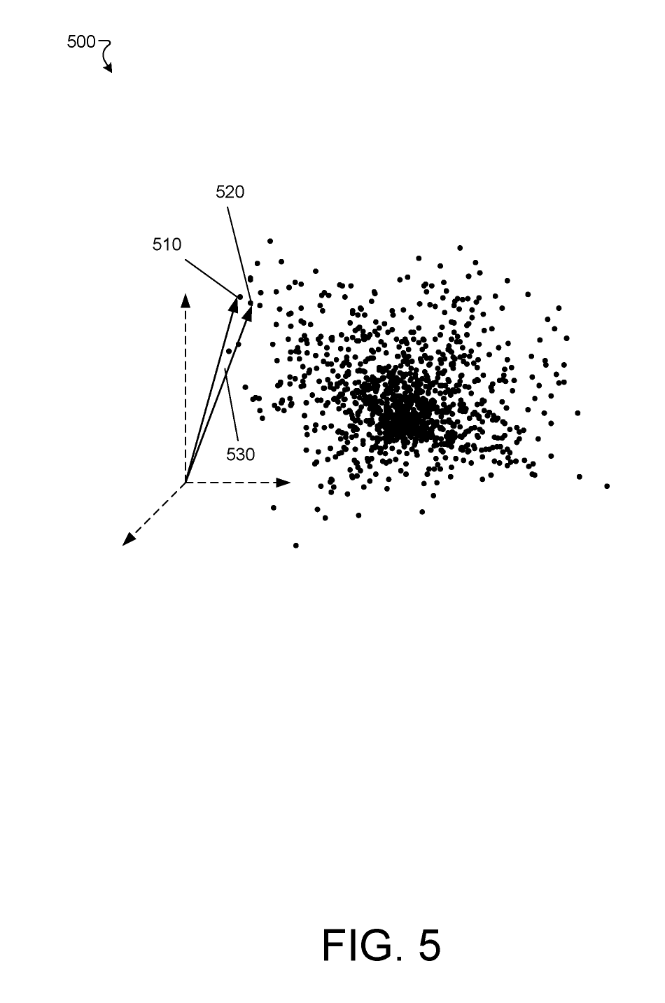

FIG. 5 is a graph 500 of an example semantic embedding model. The graph 500 is illustrated here as having three dimensional vectors for simplicity. In typical scenarios, however, the vectors may have hundreds of dimensions.

The graph 500 illustrates a model having many vectors, e.g., vector 510, at various locations in the coordinate system. Each such vector has three components and represents a keyword element of an electronic document. The semantic embedding model represented by the graph 500 represents keyword elements of a query as another vector, e.g., vector 520, and compares such a vector with any other vector, e.g., vector 510, e.g., by computing an angle 530 between the vectors.

There are typically many thousands of points in a graph such as graph 500. Comparing each keyword from a query with every point in a graph would use an extremely large amount of computing resources. One way to reduce the resources needed is to generate a k-d tree of the graph 500. Once such a k-d tree is generated, then the reference generating server 120 may then perform a nearest neighbor search to determine a subset of the graph 500 over which the most relevant point for comparison are located.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device (computer-readable medium, a non-transitory computer-readable storage medium, a tangible computer-readable storage medium) or in a propagated signal, for processing by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method of providing references to electronic documents to a student of a massive open online course (MOOC), the method comprising:
obtaining, by processing circuitry of a computer, a set of electronic documents, the set of electronic documents including a first set of keyword elements;
receiving, by the processing circuitry, a query from a student of the MOOC, the query including a second set of keyword elements;
in response to receiving the query, for each of the second set of keyword elements, generating, by the processing circuitry, a similarity score between a keyword element of the first set of keyword elements and each of the second set of keyword elements; and
performing, by the processing circuitry, a selection operation based on the similarity score to select a reference to an electronic document of the set of electronic documents that include the keyword element to the student of the MOOC.

2. The method as in claim 1, further comprising performing a machine learning operation on the first set of keyword elements to produce an embedded semantic model based on the first set of keyword elements, the semantic embedding model being configured to generate components of a vector in a multidimensional space representing a keyword element.

3. The method as in claim 2, wherein generating the similarity score between a keyword element of the first set of keyword elements and each of the second set of keyword elements includes:
generating, based on the semantic embedding model, components of a vector representing that keyword element;
generating an angle between the vector corresponding to that keyword element and a vector representing the keyword element of the first set of keyword elements, the similarity score being based on the angle.

4. The method as in claim 2, further comprising, after generating the similarity score between a keyword element of the first set of keyword elements and each of the second set of keyword elements:
obtaining another set of electronic documents, the other set of electronic documents including a third set of keyword elements; and
adjusting the semantic embedding model based on the third set of keyword elements.

5. The method as in claim 2, further comprising, in response to receiving the query:
forming a k-d tree from the multidimensional space in which the embedded semantic model is configured to generate components of a vector representing a keyword element;
performing a nearest neighbor search of the k-d tree to locate the keyword element of the first set of keyword elements.

6. The method as in claim 1, wherein the set of electronic documents include content from another MOOC; and
wherein obtaining the set of electronic documents includes retrieving the set of electronic documents from a server hosting the other MOOC.

7. A method of providing references to electronic documents to a student of a massive open online course (MOOC), the method comprising:
generating a query based on content of the MOOC, the query including a set of keyword elements describing the content;
sending the query to a reference generating server, the reference generating server being configured to locate an electronic document that include keyword elements describing content that is semantically similar to the content of the MOOC; and
receiving a reference to the electronic document from the reference generating server, the reference providing the student of the MOOC with additional content for the MOOC.

8. The method as in claim 7, wherein generating the query includes:
receiving an evaluation of the student's knowledge of the content of the MOOC; and
forming the query based on the evaluation.

9. A computer program product comprising a nontransitive storage medium, the computer program product including code that, when executed by processing circuitry of a reference generating server configured to provide references to electronic documents to a student of a massive open online course (MOOC), causes the processing circuitry to perform a method, the method comprising:
obtaining a set of electronic documents, the set of electronic documents including a first set of keyword elements;
receiving a query from a student of the MOOC, the query including a second set of keyword elements;
in response to receiving the query, for each of the second set of keyword elements, generating a similarity score between a keyword element of the first set of keyword elements and each of the second set of keyword elements; and
performing a selection operation based on the similarity score to select a reference to an electronic document of the set of electronic documents that include the keyword element to the student of the MOOC.

10. The computer program product as in claim 9, wherein the method further comprises performing a machine learning operation on the first set of keyword elements to produce an semantic embedding model based on the first set of keyword elements, the semantic embedding model being configured to generate components of a vector in a multidimensional space representing a keyword element.

11. The computer program product as in claim 10, wherein generating the similarity score between a keyword element of the first set of keyword elements and each of the second set of keyword elements includes:
generating, based on the semantic embedding model, components of a vector representing that keyword element;
generating an angle between the vector corresponding to that keyword element and a vector representing the keyword element of the first set of keyword elements, the similarity score being based on the angle.

12. The computer program product as in claim 10, wherein the method further comprises, after generating the similarity score between a keyword element of the first set of keyword elements and each of the second set of keyword elements:
obtaining another set of electronic documents, the other set of electronic documents including a third set of keyword elements; and
adjusting the semantic embedding model based on the third set of keyword elements.

13. The computer program product as in claim 10, wherein the method further comprises, in response to receiving the query:
forming a k-d tree from the multidimensional space in which the embedded semantic model is configured to generate components of a vector representing a keyword element;
performing a nearest neighbor search of the k-d tree to locate the keyword element of the first set of keyword elements.

14. The computer program product as in claim 9, wherein the set of electronic documents include content from another MOOC; and
wherein obtaining the set of electronic documents includes retrieving the set of electronic documents from a server hosting the other MOOC.

15. An electronic apparatus configured to provide references to electronic documents to a student of a massive open online course (MOOC), the electronic apparatus comprising:
a network interface;
memory; and
controlling circuitry coupled to the memory, the controlling circuitry being configured to:
obtain a set of electronic documents, the set of electronic documents including a first set of keyword elements;
receive a query from a student of the MOOC, the query including a second set of keyword elements;
in response to receiving the query, for each of the second set of keyword elements, generate a similarity score between a keyword element of the first set of keyword elements and each of the second set of keyword elements; and
perform a selection operation based on the similarity score to select a reference to an electronic document of the set of electronic documents that include the keyword element to the student of the MOOC.

16. The electronic apparatus as in claim 15, wherein the controlling circuitry is further configured to perform a machine learning operation on the first set of keyword elements to produce an semantic embedding model based on the first set of keyword elements, the semantic embedding model being configured to generate components of a vector in a multidimensional space representing a keyword element.

17. The electronic apparatus as in claim 16, wherein the controlling circuitry configured to generate the similarity score between a keyword element of the first set of keyword elements and each of the second set of keyword elements is further configured to:
generate, based on the semantic embedding model, components of a vector representing that keyword element;
generate an angle between the vector corresponding to that keyword element and a vector representing the keyword element of the first set of keyword elements, the similarity score being based on the angle.

18. The electronic apparatus as in claim 16, wherein the controlling circuitry is further configured to, after generating the similarity score between a keyword element of the first set of keyword elements and each of the second set of keyword elements:
obtain another set of electronic documents, the other set of electronic documents including a third set of keyword elements; and
adjust the semantic embedding model based on the third set of keyword elements.

19. The electronic apparatus as in claim 16, wherein the controlling circuitry is further configured to, in response to receiving the query:
form a k-d tree from the multidimensional space in which the semantic embedding model is configured to generate components of a vector representing a keyword element;
perform a nearest neighbor search of the k-d tree to locate the keyword element of the first set of keyword elements.

20. The electronic apparatus as in claim 15, wherein the set of electronic documents include content from another MOOC; and
wherein the controlling circuitry configured to obtain the set of electronic documents is further configured to retrieve the set of electronic documents from a server hosting the other MOOC.
